(19) United States
(12) Patent Application Publication
(10) Pub. No.: US 2005/0203644 A1
(43) Pub. Date: Sep. 15, 2005

(54) Method and system for collecting PLC data

(76) Inventors: Charles J. Scalfani, Laguna Niguel, CA (US); Donald L. Gaudino, Yorba Linda, CA (US)

Correspondence Address: KLEIN, O'NEILL & SINGH, 2 PARK PLAZA, SUITE 510, IRVINE, CA, 92614, US

(21) Appl. No.: 10/969,107

(22) Filed: Oct. 20, 2004

Related U.S. Application Data
(60) Provisional application No. 60/553,395, filed on Mar. 9, 2004.

(51) Int. Cl. G05B 9/02; G05B 11/01

(52) U.S. Cl. 700/79

(57) ABSTRACT

A method and system for collecting data from a programmable logic controller (“PLC”) is provided. The method includes, adding a checksum to all PLC data points within a transaction; collecting the checksum and the PLC data points; and verifying the checksum. The system includes a polling program that polls and collects data from the PLC; and a data analyzer that verifies a checksum to ensure that the data collected within a transaction is current. The checksum is added after the PLC has updated all transactional data points.

### CROSS REFERENCE TO RELATED APPLICATION

This application is related to and claims priority to the provisional U.S. patent application entitled, “METHOD AND SYSTEM FOR COLLECTING PLC DATA”, Ser. No. 60/553,395, filing date, Mar. 9, 2004, the disclosure of which is incorporated herein by reference, in its entirety.

### BACKGROUND OF THE INVENTION

1. Field of the Invention

The present invention relates to manufacturing processes, and more particularly, to collecting data from programmable logic controllers (“PLCs”) while maintaining data reliability.

2. Background

Manufacturing batch (or bulk) products is common today. Some products within the batch product category are milk, juice, oil, cosmetics, pharmaceuticals and other similar products. The term “batch” means non-discrete. A car in this sense is a discrete product, while milk during manufacturing/processing is a batch product.

Most batch manufacturing plants can be modeled after the ISA S88.01 industry standard (referred to herein as the S88 standard), published by The International Society of Measurement & Control (ISA) and incorporated herein by reference in its entirety. The S88 standard defines a model and methodology for manufacturing plants. A manufacturing unit in a manufacturing plant is a single logical device and a S88 phase is an activity that is performed on a Unit.

Currently, PLCs are used to collect data in batch manufacturing plants (and discrete product manufacturing plants). An example of one such PLC is 1756 ControlLogix™ from RockWell Automation™. Typically, PLCs collect data based on time intervals. The data is captured by a polling program (for example, an OPC server, which is an industry standard for polling data from PLCs and is incorporated herein by reference in its entirety). FIG. 1A shows a system for polling data from a PLC 101. Polling program 102 polls PLC 101 for data on a regular basis. Data analyzer 103 then analyzes the collected data.

Conventional systems using PLCS fail to establish whether data collected by polling program 102 is current at any given time. Also, conventional systems do not allow data to be read as a single transaction.

PLCs constantly read/update data points, while data is being polled (and collected) by program 102, however, PLC 101 may change a data point while data is being read.

FIG. 1D illustrates this problem. Polling program 102 reads “Parameter 2” in step 102A before PLC 101 sets its final value in step 102B. Hence, an old value for Parameter 2 is collected by polling program 102, which is unreliable.

This problem gets worse because data that is read by polling program 102 is not contiguous. This means that polling program 102 polls for data independently from the order in which data is collected which because of communication errors can cause the data to be returned in a random order. FIG. 1F shows a typical PLC data structure 108 (logical structure). Data structure 108 includes a “trigger” value that triggers data collection. Once the trigger is received, then all current data point values are processed. Data points are stored as Data A, B, C and so forth. When polling program 102 reads data, it gets data in random order, i.e., data point C may be read before B and A.

Data reliability (i.e. data is current at a given time) becomes an issue when multiple parameters are collected and analyzed for a single event, e.g. batch processing. With conventional systems, PLC data is collected and then saved in a database and analyzed later (by data analyzer 103). Since this data was not correlated to events, manufacturing plants did not have an appreciation for data reliability.

A conventional solution to solve the foregoing problem has been to use a “time delay” before the PLC writes the trigger value, (for example, 2 seconds or more), for collecting data from PLCs. This provides polling program 102 a certain time interval to read data before processing it. This solution has the undesirable effect of delaying notification of events. Also the time delay is inadequate when an event starts and stops multiple times during the delay period. Furthermore, each event requires a timer and extra code to handle the timer. Yet another shortcoming of the “time delay” technique is that it is be difficult to establish accurate time delay(s) for different PLCs and configurations. Hence, based on the foregoing, the time delay solution is not very efficient.

Another approach would be to wait for the trigger value to change and then read the current values of all the data points. This has many of the same problems of the “time delay” solution. This approach is also undesirable because it increases communication traffic between polling program 102 and the PLC.

Therefore, there is a need for a system and method that facilitates reliable data collection from PLCs.

### SUMMARY OF THE PRESENT INVENTION

In one aspect of the present invention a method for collecting data from a programmable logic controller (“PLC”) is provided. The method includes, adding a checksum to all PLC data points within a transaction; collecting the checksum and the PLC data points; and verifying the checksum. The checksum is added to the data points at the PLC stage and a polling program collects the checksum and the data points.

In yet another aspect, a system for collecting data from a PLC is provided. The system includes a polling program that polls and collects data from the PLC; and a data analyzer that verifies a checksum to ensure that the data collected within a transaction is current. The checksum is added after the PLC has updated all transactional data points.

In yet another aspect, a computer-readable medium storing computer-executable code of a process for use in a computer system for collecting data from a PLC is provided. The medium includes the process for adding a checksum to all PLC data points within a transaction; collecting the checksum and the PLC data points; and verifying the checksum.

This summary has been provided so that the nature of the invention may be understood quickly. A more complete understanding of the invention can be obtained by reference to the following detailed description of the preferred embodiments thereof concerning the attached drawings.

### BRIEF DESCRIPTION OF THE DRAWINGS

The foregoing features and other features of the present invention will now be described with reference to the drawings of a preferred embodiment. In the drawings, the same components have the same reference numerals. The illustrated embodiment is intended to illustrate, but not to limit the invention. The drawings include the following Figures:

FIG. 1A shows a prior art block diagram for collecting PLC data;

FIG. 1B shows a block diagram of a computing system that can implement the various adaptive aspects of the present invention;

FIG. 1C shows the internal architecture of the computing system in FIG. 1B;

FIG. 1D shows a table highlighting prior art PLC data collection problems;

FIG. 1E shows a block diagram for reliably collecting PLC data according to one aspect of the present invention;

FIG. 1F shows a prior art data structure;

FIG. 2 shows a block diagram of a data block in a single Transaction, according to one aspect of the present invention;

FIG. 3 shows a flow diagram for collecting data, according to one aspect of the present invention; and

FIG. 4 is a flow diagram of process steps at the PLC stage, according to one aspect of the present invention; and

FIG. 5 shows a table that illustrates reliable PLC data collection, according to one aspect of the present invention.

### DETAILED DESCRIPTION OF THE PREFERRED EMBODIMENTS

Definitions: The following definitions are provided as they are typically (but not exclusively) used in the batch product manufacturing environment, implementing the various adaptive aspects of the present invention:

“Batch”: Product that flows through one or more Units.

“Data Point”: A Data Point is a single data value that is polled from a PLC.

“OPC” Server: OPC Sever is an industry standard interface to a server program for polling data from a PLC.

“PLC”: Programmable Logic controller, used to control and monitor manufacturing processes and equipment.

“S88”: Industry Standard for modeling batch manufacturing process.

“Transactional Data Points”: Two or more Data Points that are received in a single transaction from a PLC by polling program.

“Trigger”: Trigger means a data point that is maintained to determine whether other data points should be processed. A trigger can be a flag. A change in trigger value may be sufficient to process other data points, for example, start collecting other data points or process previously collected data.

“Unit”: A single device used in a manufacturing plant, for example, a storage tank, a pasteurizer and others.

To facilitate an understanding of the preferred embodiment using the adaptive aspects of the present invention, the general architecture and operation of a computer system and the Internet will now be described. The specific architecture and operation of the preferred embodiment will then be described with reference to the general architecture.

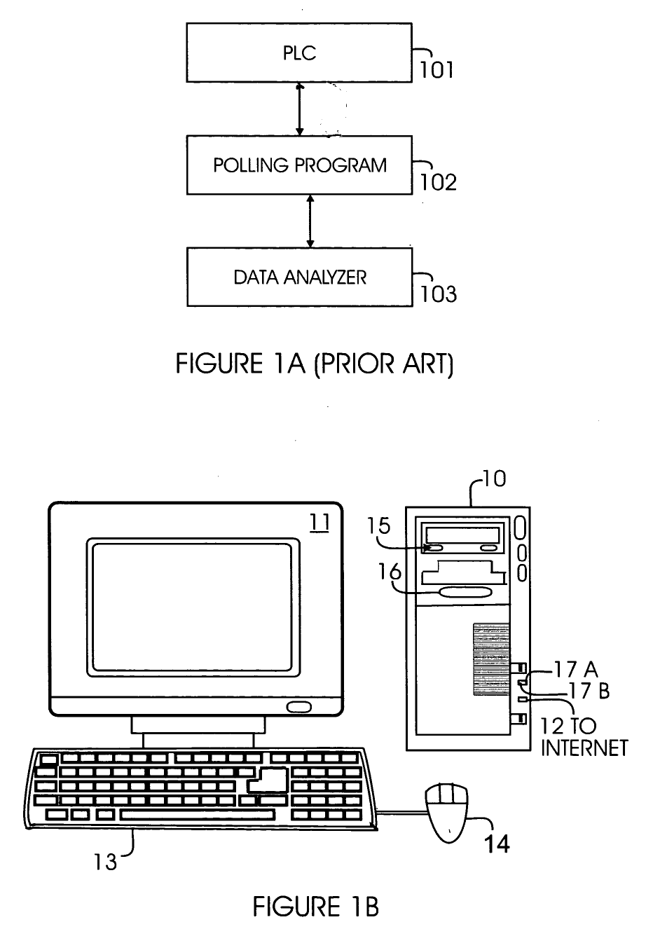

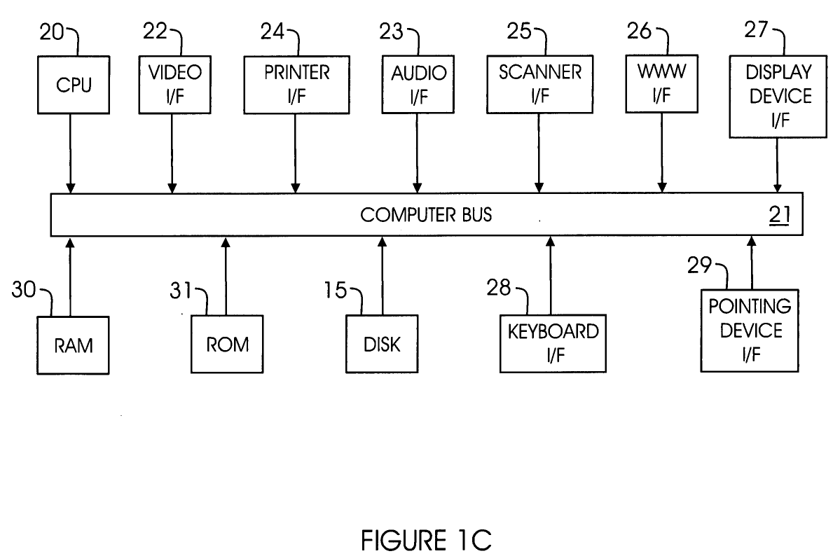

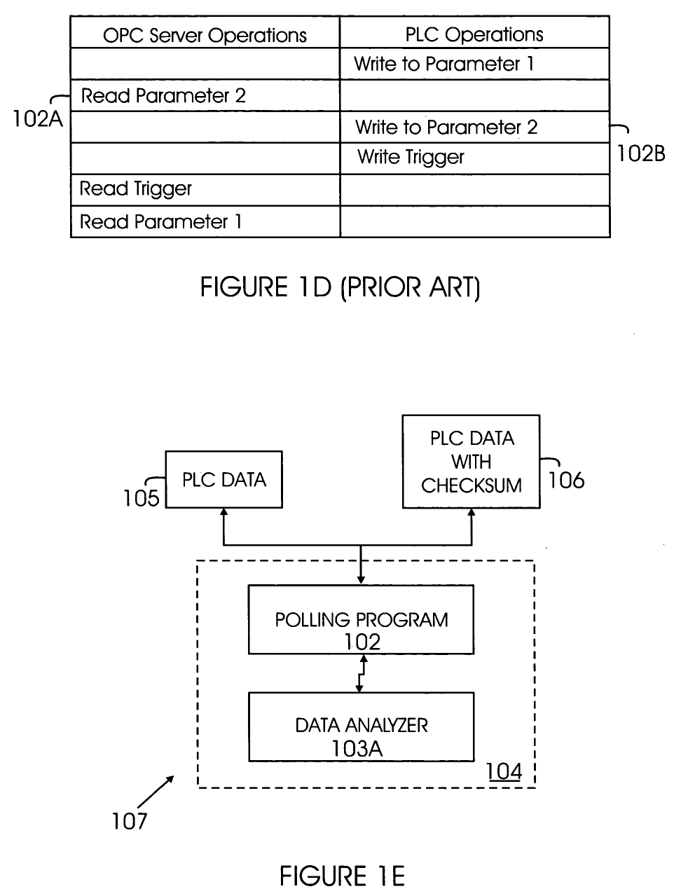

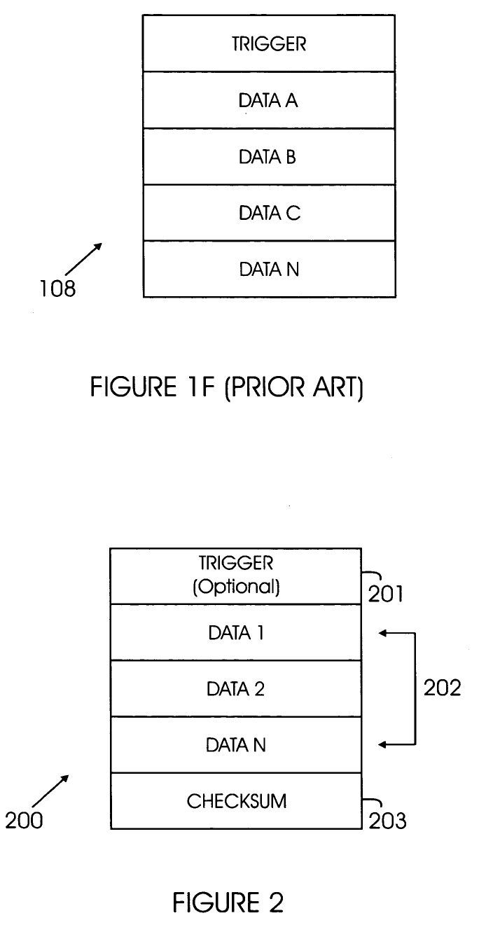

FIG. 1B is a block diagram of a computing system for performing executable process steps according to one aspect of the present invention. FIG. 1B includes a host computer 10 and a monitor 11. Monitor 11 may be a CRT type, a LCD type, or any other type of color or monochrome display. Also provided with computer 10 are a keyboard 13 for entering data and user commands and a pointing device 14 for processing objects displayed on monitor 11.

Computer 10 includes a computer-readable memory medium such as a rotating disk 15 for storing readable data. Besides other programs, disk 15 can store application programs' including web browsers by which computer 10 connects to the Internet and the systems described.

According to one aspect of the present invention, computer 10 can also access computer-readable floppy disks storing data files, application program files, and computer executable process steps embodying the present invention or the like via a floppy disk drive 16. A CD-ROM, or CD R/W (read/write) interface (not shown) may also be provided with computer 10 to access application program files, audio files and data files stored on a CD-ROM.

A modem, an integrated services digital network (ISDN) connection, or the like also provides computer 10 with an Internet connection 12 to the World Wide Web (WWW). The Internet connection 12 allows computer 10 to download data files, application program files and computer-executable process steps embodying the present invention.

Computer 10 is also provided with external audio speakers 17A and 17B to assist a listener to listen to audio files or messages that may be generated based on certain events.

It is noteworthy that the present invention is not limited to the FIG. 1B architecture. For example, notebook or laptop computers, handheld and/or wireless devices, set-top boxes or any other system capable of running computer-executable process steps may be used to implement the various aspects of the present invention.

FIG. 1C is a block diagram showing the internal functional architecture of computer 10. As shown in FIG. 1C, computer 10 includes a CPU 20 for executing computer-executable process steps and interfaces with a computer bus 21. Also shown in FIG. 1C are a video interface 22, an audio interface 23, a printer interface 24, a scanner interface 25, a WWW interface 26, a display device interface 27, a keyboard interface 28, a pointing device interface 29, and a rotating disk 15.

As described above, disk 15 stores operating system program files, application program files, web browsers, and other files. Some of these files are stored on disk 15 using an installation program. For example, CPU 20 executes computer-executable process steps of an installation program so that CPU 20 can properly execute the application program.

Random access memory (“RAM”) 30 also interfaces to computer bus 21 to provide CPU 20 with access to memory storage. When executing stored computer-executable process steps from disk 15 (or other storage media such as floppy disk 16 or WWW connection 12), CPU 20 stores and executes the process steps out of RAM 30.

Read only memory (“ROM”) 31 is provided to store invariant instruction sequences such as start-up instruction sequences or basic input/output operating system (BIOS) sequences for operation of keyboard 13.

Process steps, according to one aspect of the present invention may be performed using the Internet. Data collected by PLCs may be accessed via the Internet. The following provides a brief description of the Internet.

The Internet connects thousands of computers world wide through well-known protocols, for example, Transmission Control Protocol (TCP)/Internet Protocol (IP), into a vast network. Information on the Internet is stored world wide as computer files, mostly written in the Hypertext Mark Up Language (“HTML”). Other mark up languages, e.g., Extensible Markup Language as published by W3C Consortium, Version 1, Second Edition, October 2000, ©W3C may also be used. The collection of all such publicly available computer files is known as the World Wide Web (WWW). The WWW is a multimedia-enabled hypertext system used for navigating the Internet and is made up of hundreds of thousands of web pages with images and text and video files, which can be displayed on a computer monitor. Each web page can have connections to other pages, which may be located on any computer connected to the Internet.

A typical Internet user uses a client program called a “Web Browser” to connect to the Internet. A user can connect to the Internet via a proprietary network, such as America Online or CompuServe, or via an Internet Service Provider, e.g., Earthlink. The web browser may run on any computer connected to the Internet. Currently, various browsers are available of which two prominent browsers are Netscape Navigator and Microsoft Internet Explorer. The Web Browser receives and sends requests to a web server and acquires information from the WWW. A web server is a program that, upon receipt of a request, sends the requested data to the requesting user. A standard naming convention known as Uniform Resource Locator (“URL”) has been adopted to represent hypermedia links and links to network services. Most files or services can be represented with a URL.

URLs enable Web Browsers to go directly to any file held on any WWW server. Information from the WWW is accessed using well-known protocols, including the Hypertext Transport Protocol (“HTTP”), the Wide Area Information Service (“WAIS”) and the File Transport Protocol (“FTP”), over TCP/IP protocol. The transfer format for standard WWW pages is Hypertext Transfer Protocol (HTTP).

In one aspect of the present invention, a “checksum” (or any other technique) is associated with all the data points associated within a single transaction. A checksum is calculated when the transaction is complete. Data analyzer 103A (Figure 1E) verifies the checksum associated with the data points that are collected by polling program 102 to ensure that all collected data within a transaction is complete and reliable.

FIG. 2 shows an example of a data structure 200 that is used to define a transaction. Data structure 200 includes an optional trigger value, which is written after all the data points (A-N) 202 have been collected. Checksum 203 marks the completion of a transaction.

FIG. 1E shows an example of a system 107, according to one aspect of the present invention. PLC data 105 is collected by polling program 102 and sent to data analyzer 103A. Polling program 102 also collects PLC data with checksum 106 to ensure data integrity. Data analyzer 103A verifies the checksum. It is noteworthy that polling program 102 and data analyzer 103A may be integrated into a single module 104 run on computing system 10.

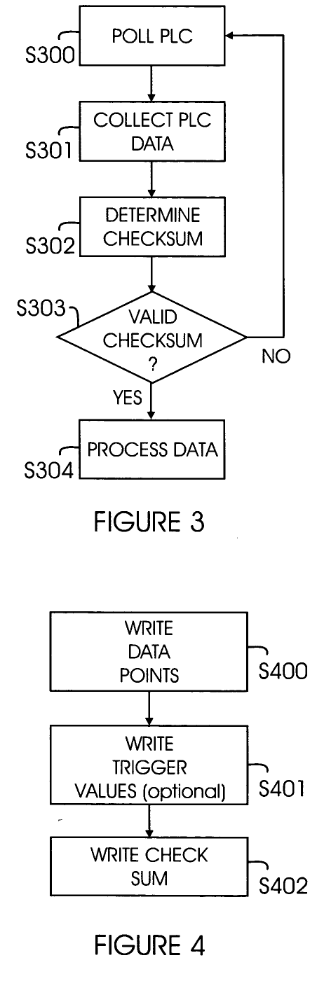

FIG. 3 shows a flow diagram used by module 107 to ensure data integrity, according to one aspect of the present invention. In step S300, the process polls PLC for data. Polling program 102 (OPC Server) polls for PLC data.

In step S301, the process collects PLC data. Polling program 102 collects PLC data.

In step S302, data analyzer 103A determines the checksum for the collected data.

In step S303, data analyzer 103A verifies the checksum for the collected data. If the checksum is acceptable, then data is processed, signifying that the most current data was collected. If the checksum does not match in step S303, then the process reverts back to step S300.

FIG. 4 shows process steps at the PLC 101 side, according to one aspect for the present invention to generate PLC data with checksum 106. In step S400, PLC 101 writes PLC data points (105). In step S401, PLC 101 optionally writes the trigger value, signifying the end of an event. In step S402, the process writes the checksum (203) for the Transaction signifying the end of a transaction.

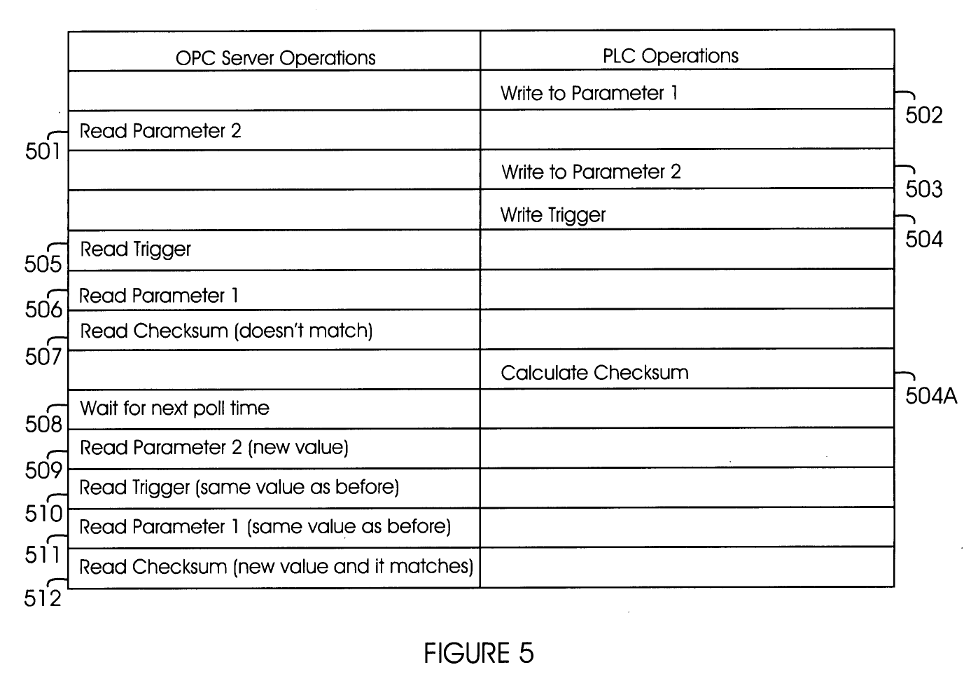

FIG. 5 shows an example of using the checksum according to the adaptive aspects of the present invention. In step 501, polling program 102 reads for example, Parameter 2, at the same time, PLC 101 writes Parameter 1 in step 502.

In step 503, PLC 101 writes to Parameter 2 and then writes the trigger in step 504. In step 505, polling program 102 reads the trigger and then in 506, Parameter 1 is read. In step 507, when the checksum is verified, there is no match since polling program 102 did not read the most current value of Parameter 2. In the meantime, in step 504A, a checksum value (203) is determined.

After step 508, when polling program starts collecting data again, the current value for Parameter 2 is collected in step 509. In step 510, the trigger value is read and the same Parameter 1 value is read in step 511. In step 512, the new checksum value is read and verified. This time the checksum is valid and the transaction is complete.

In one aspect of the present invention, cyclic redundancy check (“CRC”) code may be used to check data integrity. CRC-16 polynomial x\hat{ }16+x\hat{ }12+X\hat{ }5+1 may be used for determining data integrity. It is noteworthy that the present invention is not limited to CRC or any particular checksum technique.

In one aspect of the present invention, by adding a checksum to a set of data points within a transaction allows reliable data collection.

While the present invention is described above with respect to what is currently considered its preferred embodiments, it is to be understood that the invention is not limited to that described above. To the contrary, the invention is intended to cover various modifications and equivalent arrangements within the spirit and scope of the appended claims.

1. A method for collecting data from a programmable logic controller (“PLC”), comprising:
adding a checksum to all PLC data points within a transaction;
collecting the checksum and the PLC data points; and
verifying the checksum.

2. The method of claim 1, where the checksum is added to the data points at the PLC stage.

3. The method of claim 1, where a polling program collects the checksum and the data points.

4. A system for collecting data from a programmable logic controller (“PLC”), comprising:
a polling program that polls and collects data from the PLC; and
a data analyzer that verifies a checksum to ensure that the data collected within a transaction is current.

5. The system of claim 4, where the checksum is added after the PLC has updated all transactional data points.

6. A computer-readable medium storing computer-executable code of a process for use in a computer system for collecting data from a programmable logic controller (“PLC”), comprising:
adding a checksum to all PLC data points within a transaction;
collecting the checksum and the PLC data points; and
verifying the checksum.

7. The computer readable medium of claim 6, where the checksum is added to the data points at the PLC stage.

8. The computer readable medium of claim 6, where a polling program collects the checksum and the data points.
